(19) United States
(12) Patent Application Publication
(10) Pub. No.: US 2023/0259950 A1
(43) Pub. Date: Aug. 17, 2023

(54) CLINICAL PARTNER EVENT RELATIONSHIP MANAGEMENT

(71) Applicant: Align Technology, Inc., San Jose, CA (US)

(72) Inventors: Kimberly Holmes, Flower Mound, TX (US); Mitra Derakhshan, Herndon, VA (US)

(21) Appl. No.: 18/167,790

(22) Filed: Feb. 10, 2023

Related U.S. Application Data
(60) Provisional application No. 63/309,988, filed on Feb. 14, 2022.

(51) Int. Cl. G06Q 30/01; G06Q 10/1093

(52) U.S. Cl. CPC G06Q 30/01; G06Q 10/1093

(57) ABSTRACT

Systems, methods, and computer-readable media for coordinating events based on enterprise-partner relationship management. Specifically, a partner of a clinical enterprise can be identified. Further, one or more interaction events during which partners of the clinical enterprise present information related to the clinical enterprise can be identified. As follows, access for managing the participation of the partner in association with an interaction event of the one or more interaction events can be provided.

### RELATED APPLICATIONS

This patent application claims the benefit under 35 U.S.C. §119(e) of U.S. Provisional Application No. 63/309,988, filed Feb. 14, 2022.

### TECHNICAL FIELD

The present technology pertains to customer event and engagement management based on customer relationship management, and in particular, to managing and coordinating events for an enterprise and customers based on customer relationship management.

### BACKGROUND

Maintaining quality relationships with customers is vitally important to an enterprise. An enterprise of all sizes needs to keep track of its customer information and interactions, keep all information up to date, facilitate communication and interactions with customers, and provide support for customers to meet their needs. In particular, an enterprise needs to provide suitable support for customers in engaging in enterprise-related events. For example, it is important that suppliers of dental products and services maintain quality relationships with dentists, faculty, or key opinion leaders and deliver support for them to engage in dentistry trade shows, meetings, or conventions by managing and coordinating such events.

Event management involves the selection and coordination of many entities and various tasks such as scheduling, logistics, budgeting, and managing participant relations. From securing an appropriate speaker to participate in the event to arranging accommodations for the speaker, there are a lot of things to juggle before the event. In addition to a significant amount of logistics, it is also crucial to facilitate efficient and constant communication between multiple parties such as hosts, sponsors, participants, and speakers. For example, it is important that suppliers of dental products and services select a suitable customer(s) who may be speakers, key opinion leaders, or faculty members to engage in the dentistry trade shows, meetings, or conventions. Also, the supplies of dental products and services need to proactively interact with the customers to arrange accommodations and prepare for the events. It becomes difficult for an enterprise to sufficiently manage the engagements of its customers due to the extensive amount of tasks involved in the planning and the difficulty of managing diverse customers around the world.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example environment for managing and coordinating events based on enterprise-partner relationship management, in accordance with some examples.

FIG. 2 illustrates an example environment of event management system 110 for managing enterprise-partner relationships and further facilitating and coordinating the participation of partners in the enterprise-related events, in accordance with some examples.

FIG. 3 is a screenshot of an example interface for managing partner information in association with coordinating events, in accordance with some examples.

FIG. 4 illustrates a flowchart for an example method of providing access for managing events based on partner relationship management, in accordance with some examples.

FIG. 5 illustrates a flowchart for an example method of providing access to a partner for managing events based on partner relationship management, in accordance with some examples.

FIG. 6A illustrates a flowchart for an example method of coordinating and facilitating the participation of a partner at an event, in accordance with some examples.

FIG. 6B illustrates a flowchart for an example method of managing peer interaction on a peer-to-peer platform, in accordance with some examples.

FIG. 7 illustrates an example computing system, in accordance with some examples.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

A method can include identifying a partner of a clinical enterprise. Further, one or more interaction events during which partners of the clinical enterprise present information related to the clinical enterprise can be identified. As follows, access for managing participation of the partner in association with an interaction event of the one or more interaction events can be provided.

A system can include one or more processors and at least one computer-readable storage medium storing instructions which, when executed by the one or more processors, cause the one or more processors to identify a partner of a clinical enterprise. The instructions can also cause the one or more processors to identify one or more interaction events during which partners of the clinical enterprise present information related to the clinical enterprise. As follows, the instructions can cause the one or more processors to provide access for managing participation of the partner in association with an interaction event of the one or more interaction events.

A non-transitory computer-readable storage medium having stored therein instructions which, when executed by one or more processors, cause the one or more processors to identify a partner of a clinical enterprise. The instructions can also cause the one or more processors to identify one or more interaction events during which partners of the clinical enterprise present information related to the clinical enterprise. As follows, the instructions can cause the one or more processors to provide access for managing participation of the partner in association with an interaction event of the one or more interaction events.

A method can include identifying a partner of a clinical enterprise. Further, data related to partners of the clinical enterprise participating in one or more interaction events during which the partners of the clinical enterprise present information related to the clinical enterprise can be maintained. As follows, access to the partner for managing participation of the partner in association with an interaction event of the one or more interaction events can be provided based on the data related to the partners of the clinical enterprise including the partner of the clinical enterprise participating in the one or more interaction events.

A system can include one or more processors and at least one computer-readable storage medium storing instructions which, when executed by the one or more processors, cause the one or more processors to identify a partner of a clinical enterprise. The instructions can also cause the one or more processors to maintain data related to partners of the clinical enterprise participating in one or more interaction events during which the partners of the clinical enterprise present information related to the clinical enterprise. Further, the instructions can also cause the one or more processors to provide access to the partner for managing participation of the partner in association with an interaction event of the one or more interaction events based on the data related to the partners of the clinical enterprise including the partner of the clinical enterprise participating in the one or more interaction events.

A non-transitory computer-readable storage medium having stored therein instructions which, when executed by one or more processors, cause the one or more processors to identify a partner of a clinical enterprise. The instructions can also cause the one or more processors to maintain data related to partners of the clinical enterprise participating in one or more interaction events during which the partners of the clinical enterprise present information related to the clinical enterprise. Further, the instructions can also cause the one or more processors to provide access to the partner for managing participation of the partner in association with an interaction event of the one or more interaction events based on the data related to the partners of the clinical enterprise including the partner of the clinical enterprise participating in the one or more interaction events.

A method can include identifying a partner of a clinical enterprise. An interaction event during which the partner is engaged to present information related to the clinical enterprise can be identified. Further, information related to the clinical enterprise that the partner is engaged to present during the interaction event can be received from the partner. As follows, approval of the information before the interaction event can be facilitated.

A system can include one or more processors and at least one computer-readable storage medium storing instructions which, when executed by the one or more processors, cause the one or more processors to identify a partner of a clinical enterprise. The instructions can also cause the one or more processors to identify an interaction event during which the partner is engaged to present information related to the clinical enterprise. Further, the instructions can cause the one or more processors to receive, from the partner, information related to the clinical enterprise that the partner is engaged to present during the interaction event. Additionally, the instructions can cause the one or more processors to facilitate approval of the information before the interaction event.

A non-transitory computer-readable storage medium having stored therein instructions which, when executed by one or more processors, cause the one or more processors to identify a partner of a clinical enterprise. The instructions can also cause the one or more processors to identify an interaction event during which the partner is engaged to present information related to the clinical enterprise. Further, the instructions can cause the one or more processors to receive, from the partner, information related to the clinical enterprise that the partner is engaged to present during the interaction event. Additionally, the instructions can cause the one or more processors to facilitate approval of the information before the interaction event.

### Description

As previously described, maintaining quality relationships with customers is vitally important to an enterprise. To do so, an enterprise needs to manage customers’ information and interactions up to date (optionally including interactions between customers and/or interactions between partners and/or service provides such as doctors), provide easily accessible communication channels, and provide proper support and resources to cater to customers’ needs. In particular, it is important that an enterprise maintains quality relationships with individuals who may provision the products and services of the enterprise to users or present the enterprise-related information to an audience of interest (e.g., potential users or customers of the products and services of the enterprise). For example, suppliers of dental products and services need to maintain quality relationships with dentists, faculty, or key opinion leaders in a dental field and further deliver support for them to engage in dentistry events such as trade shows, meetings, webinars, or conventions where they can present information relating to the products and services of the enterprise.

Event management involves the selection and coordination of many entities and various tasks such as scheduling, logistics, budgeting, and managing participant relations. Whether the event is global, national, local, or virtual, from securing an appropriate speaker to participate in the event to arranging accommodations for the speaker, there are a lot of things to juggle before the event. In addition to a significant amount of logistics, it is also crucial to facilitate efficient and constant communication between multiple parties such as hosts, sponsors, participants, and speakers. For example, it is important that suppliers of dental products and services select suitable customers who may be speakers, key opinion leaders, or faculty members to engage in the dentistry trade shows, meetings, or conventions. Also, the suppliers of dental products and services need to proactively interact with the customers to arrange accommodations and prepare for the events. It becomes difficult for an enterprise to sufficiently manage the engagements of its customers due to the extensive amount of tasks involved in the planning and the difficulty of managing diverse customers around the world.

A huge portion of customer information management and event management has been performed manually and individually. However, such decentralized event management can be time-consuming and inefficient for all parties involved. Any records or data can be easily lost between numerous exchanges of emails, spreadsheets, invoices, and presentations between multiple parties. Also, the inability to effectively and timely communicate can cause miscommunication and confusion throughout the event management.

Therefore, there exists a need for a centralized tool that allows an enterprise to maintain comprehensive customer information and find adequate customers to participate in enterprise-related events. As follows, there exists a need for an event management system that keeps track of customer information up to date in one place and coordinates engagements of the customers in enterprise-related events.

The present technology includes systems, methods, and computer-readable media for solving these problems and discrepancies. Specifically, the present technology involves systems, methods, and computer-readable media for managing customer information and relationships for identifying customers to participate in enterprise-related events. Additionally, the present technology involves systems, methods, and computer-readable media for facilitating and coordinating the participation of customers at enterprise-related events based on customer relationship management. Additionally, embodiments of the present technology include a platform that provides a peer-to-peer community through which customers, end-users, suppliers, doctors, etc. can communicate with each other and exchange ideas. The platform may provide an ability for end-users, doctors, customers, suppliers, etc. to post topics, organize discussions, perform peer-review of cases, and so on.

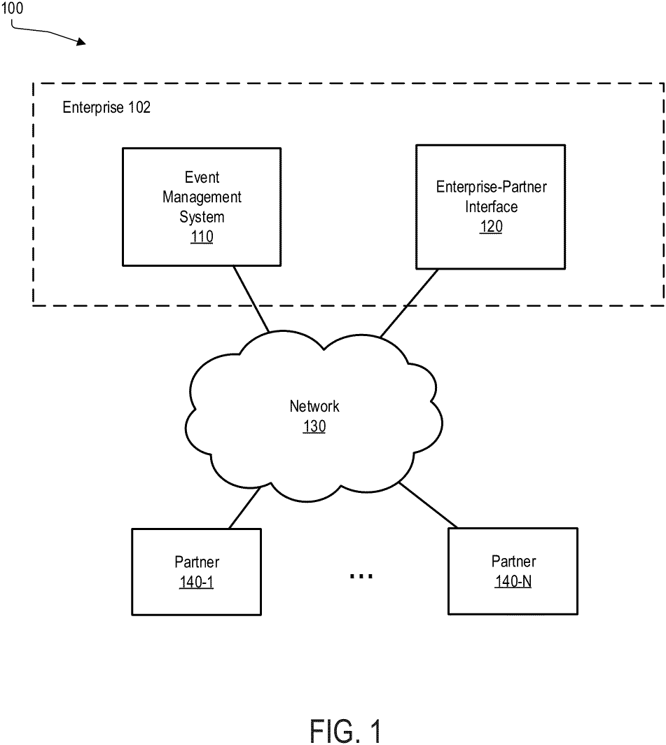

FIG. 1 illustrates an example environment 100 for managing and coordinating events based on partner relationship management. The environment 100 shown in FIG. 1 includes an enterprise 102, an event management system 110, an enterprise-partner interface 120, network 130, and a first partner 140-1 to a N^{th} partner 140-N (herein referred collectively as the “partners 140”). According to some examples, enterprise 102 including the event management system 110 and the enterprise-partner interface 120 can be connected to the partners 140 through network 130.

An enterprise (e.g., enterprise 102 in the environment 100 shown in FIG. 1), as used in the present disclosure, can be an entity in a healthcare/clinical context such as dental education contexts, medical devices contexts, or other treatment planning contexts. Specifically, the enterprise can be a clinical enterprise that provides clinical education to its members or the general public or a clinical product provider who distributes clinical products through a provider network. For example, the enterprise can be a dental product supplier who manufactures and distributes dental appliances such as dental braces and/or orthodontic aligners through the provider network consisting of dentists or orthodontists that facilitate the provisioning of the dental braces to patients. In embodiments, the dental appliances may be aligners with attachments (e.g., preformed and/or bonded attachments), aligners without attachments, palatal expanders, dental braces (e.g., wires and brackets), retainers, dental appliances to treat class I malocclusions, dental appliances to treat class II malocclusions, or dental appliances to treat class III malocclusions, and so on. In other examples, the enterprise can be a university or a professional association that provides ongoing education to various members or to the general public.

A partner (e.g., partners 140 in the environment 100 as shown in FIG. 1), as used in the present disclosure, is an entity or individual who may present the information relating to the products and/or services of the enterprise 102 to users or provision products or services from the enterprise 102 to users. Specifically, the partner can be a contracted speaker of the enterprise, a faculty member of the enterprise, an expert in a field associated with the enterprise, or a product provider of the clinical enterprise. For example, the partner can be a dentist who is contracted with a supplier of dental appliances and participate in global dental trade shows to present the dental appliances manufactured and distributed by the supplier.

In some examples, partners 140 can be disassociated from enterprise 102 of network 130. Specifically, partners 140 can be representatives of the enterprise in their capacity to provision products provided by enterprise 102, but otherwise remain distinct from enterprise 102. As a result, the partners 140 can be customers of enterprise 102. More specifically, the partners 140 can be customers in that they place or otherwise facilitate the placement of orders for products from enterprise 102, e.g., through network 130, and receive the products, e.g., through network 130. In the present disclosure, it is understood that the term “partners” can also be referred to as “customers.”

According to some examples, enterprise 102 can interact with partners 140 through network 130. In some examples, network 130 can be maintained by, or otherwise associated with, enterprise 102. As follows, network 130 can be any applicable communication network for facilitating communication and interaction between enterprise 102 and partners 140 and/or for facilitating communication between different partners 140 (e.g., a peer-to-peer community between doctors). For example, network 130 can be a provider network, which includes a group of doctors, health care providers, hospitals, pharmacies, and/or facilities in the health care industries. In another example, network 130 can include a network of dental product suppliers for controlling the provisioning of dental aligners that are manufactured by the clinical enterprise (e.g., enterprise 102) to patients through various dental providers. In some examples, network 130 can be a network associated with provisioning a specific dental product to a patient. In particular, the dental care provider network can be a network of a dental product supplier of the dental product. In some embodiments, a peer-to-peer communication network is set up between a particular class of partners (e.g., between doctors) and/or between partners that share some commonality such as an access level to enterprise information. In some embodiments, network 130 includes multiple networks, such as a network of doctors, a network of partners, a network of dental product suppliers, and so on.

In some instances, partners 140 can be coupled to the event management system 110 and/or the enterprise-partner interface 120 through network 130. In some instances, partners 140 can be coupled to the event management system 110 and/or a peer-to-peer community interface and/or platform (not shown) though network 130. In the example environment 100 shown in FIG. 1, event management system 110 and enterprise-partner interface 120 are shown to be separate from network 130. However, in various embodiments, event management system 110, enterprise-partner interface 120 and/or the peer-to-peer community interface can be included as part of network 130. Further, in the example environment 100 shown in FIG. 1, event management system 110 and enterprise-partner interface 120 are integrated as part of enterprise 102. Specifically, event management system 110 and enterprise-partner interface 120 are integrated as part of enterprise 102 for maintaining partners’ information and relationships and managing engagements of partners 140 at enterprise-related events. The peer-to-peer community interface and/or platform may also be integrated as part of enterprise 102 for maintaining partner’s information and discussions, data, communications, topics, cases, etc. between partners that belong to the peer-to-peer community provided by the peer-to-peer community interface and/or platform.

According to some examples, an event can be a planned occasion or activity. In the present disclosure, it is understood that the term “event” as used herein broadly can be referred to as a social occasion and an activity. For example, an event can include social occasions (e.g., speaking events) and/or activities such as research, pilots, customer relationships, studies, product management, technical design assessment (TDA), limited market release (LMR), and so on. Further examples of an event can include, but are not limited to, a blended event, a hybrid event, an on-demand event, an on-site event, a virtual event, a clinical study, a doctor panel, an early feasibility study, a technical design assessment, a limited market release, a doctor mentoring, clinical trials, research and development activities, market research, clinical content development, white papers, and publications. In some examples, an event can be sponsored by an enterprise, a company, or an industry.

In some examples, enterprise-partner interface 120 functions as an interface through which enterprise 102 can identify a suitable partner to engage in enterprise-related events and contact the partner or facilitate communications with the partner to promote the engagements in enterprise-related events. Similarly, the peer-to-peer platform can function as an interface between peers (e.g., partners, doctors, suppliers, etc.) through which partners can exchange information such as patient case details, medical images (e.g., x-rays, three-dimensional (3D) models of dental arches), treatment plans, ideas, research, and so on. The peer-to-peer platform can also serve as a messaging platform between peers, a notification system, a reminder system, and so on.

In other examples, enterprise-partner interface 120 functions as an interface through which partners 140 can manage their qualifications, credentials, languages, availabilities, contact information, industry affiliations, and other attributes of their profiles to provide to enterprise 102. Further, partners 140 can submit invoices, process payments for engagements/events that they participated in, and track event details through enterprise-partner interface 120.

According to some examples, event management system 110 can function to manage information related to partners 140. For example, the partners’ information can include qualifications, education, credentials, industry affiliations, languages, geographic information (e.g., locations), types of services or practice, statuses, and/or any other applicable attributes of partners 140.

For example, the partners’ information can include characteristics of the partners such as a subject matter of which partners 140 have presented at a similar event in the past, a subject matter of which partners 140 is specialized in, a subject matter of which partners 140 can present at enterprise-related events, cases that the partners 140 have worked on, etc.

In some examples, the partners’ information can include relationships of partners 140 with enterprise 102. As follows, event management system 110 can keep track of interactions between enterprise 102 and partners 140 such as partners’ past involvements in enterprise-related events, personal interactions between representatives of enterprise 102 and partners 140, and so on.

In some instances, the partners’ information can include a temporal availability (e.g., no availability on weekends, blackout dates, etc.), geographical availability, dietary restrictions (e.g., allergies, religious food restrictions, etc.), special accommodations such as disabilities, medical conditions, or other partners’ preferences (e.g., types of lodging, modes of transportations, duration of travel, etc.).

In some embodiments, discussion topics and conversations between partners may be managed by the peer-to-peer community platform. Discussion topics and/or conversations may be open to all partners having a particular classification (e.g., all doctors, all partners participating in a particular program, etc.). Some discussion topics and/or conversations may be limited to two or a few partners. In some embodiments, each of the partners that are allowed to join a topic or discussion/conversation in the peer-to-peer community platform have a particular clearance level (e.g., all have signed non-disclosure agreements related to a particular enterprise product, service, offering, etc.). Accordingly, the peer-to-peer community platform may limit the ability of some partners from viewing or participating in specific topics, threads, discussions, conversations, etc. The access to and/or ability to disseminate content of the topics, threads, discussions, conversations, etc. may be controlled by the peer-to-peer community platform to maintain confidentiality where appropriate. In some embodiments, the peer-to-peer community platform may perform analytics on information, data, communications, etc. maintained by the peer-to-peer community platform.

In some embodiments, partners or peers on the peer-to-peer platform can search for topics and/or other partners/peers meeting one or more search criteria. For example, partners/peers may search for other partners/peers having a particular specialty, having a particular geographic area, having a particular number of years of experience, who have spoken at particular types of events previously, and so on. Partners/peers may also search for other partners/peers using a name search. In embodiments, each partner/peer on the peer-to-peer platform has been vetted by enterprise 102 and has signed a non-disclose agreement (NDA). Accordingly, any partner/peer on the peer-to-peer platform can safely send confidential information to any other partner/peer on the peer-to-peer platform without violating confidentiality in embodiments. Additionally, referrals may be made between partners/peers on the platform with a reliance on the vetting process that was performed on any member of the platform in order for that member to have joined the platform. In embodiments, enterprise 102 monitors the agreements of each of the partners 140-1 through 140-N who have joined the network 130 (e.g., the peer-to-peer platform), and automatically revokes access for members who violate one or more membership criteria, such as certification status, accreditation status, contract status, NDA status, and so on.

According to some examples, event management system 110 can maintain a database to store the information of partners 140 including characteristics of partners 140 in relation to enterprise 102 as described herein. In some examples, the database to store the partners’ information is a cloud, which can be accessed through a cloud platform. In some embodiments, the database stores all topics, threads, discussions, conversations, etc. managed by the peer-to-peer community interface.

According to some examples, event management system 110 can manage enterprise-related events during which information related to the enterprise can be presented. Specifically, event management system 110 can manage enterprise-related events where partners 140 can participate or present information related to the products or services provided by enterprise 102. For example, a supplier of dental products (e.g., enterprise 102) can maintain a list of dentistry trade shows, meetings, or conventions, whether global, national, regional, virtual, or a hybrid, where partners 140 to participate to promote products and services provided by the supplier and present related information to the audience. Further, in managing enterprise-related events, event management system 110 can maintain event-related information such as details of the event including topics, locations, dates, sponsors, programs, activities, rates, attire requirements, etc.

Further, event management system 110 functions to identify one or more candidate partners for participating in one or more of the enterprise-related events based on the partners’ information as previously described, for example, qualifications, education, credentials, industry affiliations, languages, geographic information, types of services or practice, statuses, any other applicable attributes of partners, characteristics, relationships with enterprise, a temporal availability, a geographical availability, special accommodations such as disabilities, medical conditions, or other partners’ preferences.

In some examples, event management system 110 can use the partners’ information as one or more filters for filtering a candidate partner(s) to participate in the enterprise-related events, to participate in one or more groups or topics on the peer-to-peer platform, and/or for finding a partner to connect with one-on-one. Examples of the filters can include but are not limited to, a temporal availability of the partners in relation to a temporal schedule of the event, a geographical availability filter for filtering the plurality of partners based on a geographic availability of the partners in relation to a geographic schedule of the event, an experience level filter for filtering the plurality of partners based on an experience level of the partners in relation to a subject matter of the event, a role filter for filtering the plurality of partners based on a role of the partners in relation to the event, a faculty tier filter for filtering the plurality of partners based on a faculty tier of the partners, a priority filter for filtering the plurality of partners based on a priority of the partners in relation to the enterprise, or a combination thereof. With respect to searches and/or filters not associated with an event, any of the above criteria may be applied, but the criteria may not be associated with any event. In an example, a supplier of dental products can, via event management system 110, identify a candidate dentist who can present information relating to dental appliances manufactured and distributed by the supplier at a global dentistry conference. In another example, if the conference is to be held on Saturday, event management system 110 can exclude partners whose temporal availability does not include a Saturday. In another example, for a dental aligner convention in South America, event management system 110 can identify a candidate dentist or orthodontist who specializes in aligners and speaks Spanish.

In some examples, event management system 110 functions to manage the participation of partners 140 in enterprise-related events and/or in topics managed by the peer-to-peer community platform. In some examples, event management system 110 sends out messages to partners (e.g., partners on the peer-to-peer community platform) with information such as upcoming news and/or events. In some embodiment, event management system 110 sends out different classes or categories of messages and/or notifications. In one embodiment, a first class of notifications (e.g., very important notifications) are provided as a pop-up on a partner’s dashboard. The partner in some embodiments needs to acknowledge receipt of the notification (e.g., that they have read contents of the notification) before the notification will be removed from the dashboard or user interface. In one embodiment, a second class of notifications (e.g., non-urgent notifications) cause an icon or symbol to be shown on the user interface or dashboard for a partner. The partner may navigate to their messages via the user interface/dashboard, and may read the notification at their leisure. Once the partner has opened and/or read the notification, the icon or symbol associated with the notification may no longer be shown on the user interface/dashboard.

As described previously, event management system 110 can determine a candidate partner to participate in an identified enterprise-related event and/or to be included in a topic of the peer-to-peer community platform. Also, event management system 110 can, based on the candidate partner’s information, facilitate the participation of the candidate partner by catering to the candidate partner’s preferences or needs, which may be indicated in the partners’ information. In some examples, event management system 110 can invite partners to join particular topics of the peer-to-peer community platform (e.g., based on programs that those partners are participating in, access levels of the partners, and so on). In some examples, event management system 110 can facilitate the participation of partners 140 in one or more of the topics of the peer-to-peer community platform by providing invitations to join the topics and/or by automatically granting access to topics for partners that meet one or more criteria. In embodiments, an enterprise and/or a partner may invite partners to join one or more topics, discussions, etc. For example, a partner may invite one or more other partners on the peer-to-peer community platform to join a topic. In some embodiments, an enterprise may or may not be included in the topic. Accordingly, some topics may be between partners and may not be accessible to the enterprise.

In some examples, event management system 110 can facilitate the participation of partners 140 in one or more of the enterprise-related events through enterprise-partner interface 120. Specifically, enterprise-partner interface 120 functions as an interface through which enterprise 102 can contact partners 140. As follows, event management system 110 can instruct representatives to contact or facilitate the representatives contacting partners 140 through the enterprise-partner interface 120 to promote or schedule the participation of partners 140 in enterprise-related events.

According to some examples, event management system 110 functions to coordinate and schedule the engagement of partners 140 in the enterprise-related event. In some examples, event management system 110 can provide enterprise 102 with access to scheduling tools for scheduling the partner(s) to participate in the enterprise-related event. Based on input that is generated by enterprise 102 through the scheduling tools, event management system 110 can schedule the partner(s) to participate in the event. In some examples, input can be based on the partners’ information such as partners’ attributes, characteristics, or travel preferences. For example, event management system 110 can identify needs of the partner(s) in participating in the event and coordinate the performance of the needs of the partner(s).

In some examples, event management system 110 functions to manage communications between enterprise 102 and partners 140 and/or between partners 140 (e.g., for peer-to-peer communications). In some examples, such communications between enterprise 102 and partners 140 can be also facilitated by enterprise-partner interface 130. In some examples, communications between different partners 140 can be facilitated by the peer-to-peer community interface. Further, event management system 110 can facilitate an exchange of communication between enterprise 102 and partners 140, for example, via a message, a chat, or any suitable communication channels.

In some examples, event management system 110 can provide partners 140 with access to participation information such as event details (e.g., dates, locations, programs), bookings (e.g., flights, hotels, or itinerary), accommodations, etc. Further, event management system 110 can provide partners 140 with access to event feedback gathered from participants in the enterprise-related events.

In some instances, event management system 110 can control the degree of accessibility of partners 140 to the participation information and/or to topics or threads of the peer-to-peer community platform, event feedback, or any other information related to the enterprise-related events based on a status of partners 140 in relation to enterprise 102. For example, a doctor on a contractual basis may be provided with limited access to internal data or confidential information of other partners of enterprise 102 or participants of the event, and/or to topics or message groups or boards of the peer-to-peer community platform.

According to some examples, event management system 110 functions to manage communications between enterprise 102 and partners 140 regarding information to be presented by partners 140 during the enterprise-related events. Specifically, event management system 110 can receive, from partners 140, information related to enterprise 102 that partners 140 are engaged to present during the enterprise-related events. Examples of the information can include but are not limited to presentation materials, transcripts, samples, slides deck, videos, or any other applicable information that can be used during the presentation at the enterprise-related events.

Further, event management system 110 functions to facilitate approval of the information received from partners 140 before the enterprise-related events. In some examples, event management system 110 can send the information to a clinical department associated with enterprise 102. In turn, event management system 110 receives feedback from the clinical department regarding the information to be presented during the enterprise-related events.

In some instances, event management system 110 can send the information to a legal department associated with enterprise 102 to review the information in view of any potential violation of rules, laws, or regulations. In turn, event management system 110 receives feedback from the legal department regarding the information to be presented during the enterprise-related events.

In some examples, event management system 110 can send the information to a regulatory department associated with enterprise 102 to confirm regulatory compliance of the information. In turn, event management system 110 receives feedback from the legal department regarding the information to be presented during the enterprise-related events.

In some instances, event management system 110 can send the information to a panel consisting of peer partners or a few selected partners of enterprise 102. In turn, event management system 110 receives feedback or comments from the panel regarding the information to be presented during the enterprise-related events. In some embodiments, such feedback is handled via topics, subjects, threads, etc. of the peer-to-peer community platform.

In some embodiments, a partner (e.g., a doctor) may be sent an invitation to participate in (e.g., speak at and/or present at) an event. This invitation may show up as a message on that partner’s dashboard or user interface (e.g., associated with to event management system 110 and/or enterprise-partner interface 120). In some embodiments, an email is sent to a personal email account of the partner. The email may contain icons, buttons, etc. for accessing the event management system 110, enterprise-partner interface 120, network 130, etc. In one embodiment, the email contains icons, buttons, etc. that may be selected to cause a reply message to be automatically sent to the event management system 110. The partner may respond to the invitation by accepting the invitation or declining the invitation via the user interface and/or via the email.

An invitation to participate in an event may indicate whether a partner will need to provide a presentation and/or other materials for their participation in the event. The partner may upload a presentation and/or other materials via the user interface. Such uploaded presentation and/or other materials may be referred to as partner provided materials. Once the presentation and/or other materials are uploaded, they may be distributed to one or more other entities, partners, individuals, teams and/or departments of enterprise 102 for approval. Each such entity, individual, team, department, etc. that needs to approve uploaded presentations and/or materials may be sent a notification to review and provide approval and/or feedback. Such notifications may be sent as messages within the network 130 and/or as emails to personal email accounts. In embodiments, any approver can see who else has already approved a presentation/materials and/or still needs to approve a presentation/materials. Any approver may conditionally approve a presentation and/or materials. Conditional approval may be accompanied by one or more conditions that need to be satisfied for approval to proceed. For example, a conditional approval may indicate that a presentation is approved provided that trademark symbols be added where appropriate to the presentation.

According to some examples, event management system 110 can facilitate the collaborative transfer of the information between multiple departments of enterprise 102 (e.g., a clinical department, a legal department, a regulatory department, or a panel) for reviewing and approving the information. Further, the collaborative transfer can include transferring department-specific data related to the approval of the information between the multiple departments. In some embodiments, such collaborative transfer is handled via topics, subjects, threads, etc. of the peer-to-peer community platform.

According to some examples, the information received from partners 140 can be examined based on auditing rules. As follows, event management system 110 can determine the length of time to store the information in a database associated with enterprise 102 (e.g., partner information database or event information database).

In some examples, event management system 110 functions to inform partners 140 whether the information is approved before the enterprise-related events based on the feedback (e.g., approval or rejection) and reasons for the feedback. For example, event management system 110 can inform partners 140, when the information is rejected, of reasons why the information is rejected.

According to some examples, event management system 110 can receive modified information from partners 140 before the enterprise-related events. Further, event management system 110 can facilitate approval of the modified information before the enterprise-related events, for example from a clinical department, a legal department, a regulatory department, or a panel.

Further, event management system 110 functions to manage the transfer of consideration (i.e., payments) to partners 140 based on the participation of the partner in the enterprise-related event(s). For example, partners 140 can submit their invoices, requests for reimbursements, or receipts based on their participation in the enterprise-related event. As follows, event management system 110 can transfer the consideration (i.e., issue the payments) to partners 140.

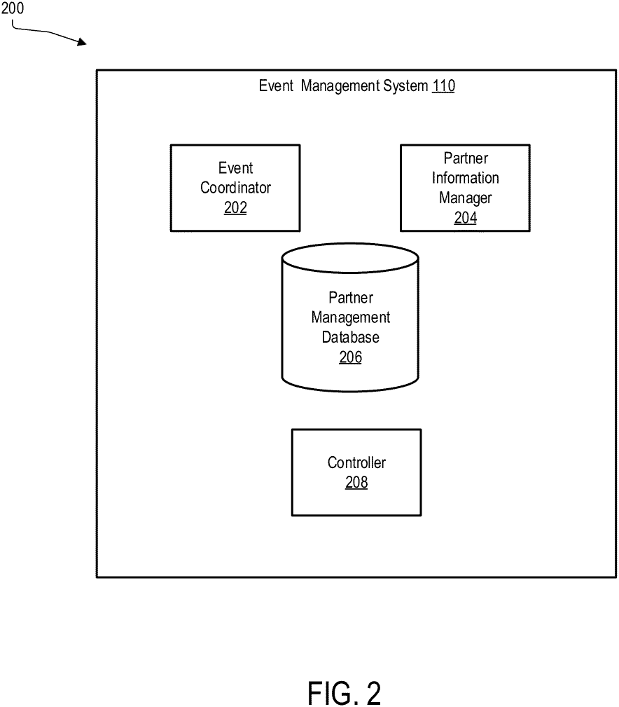

FIG. 2 illustrates an example environment 200 of event management system 110 for managing enterprise-partner relationships and further facilitating and coordinating the participation of partners in the enterprise-related events. The example event management system 110 shown in FIG. 2 can be implemented in an applicable environment, such as the environments discussed herein. For example, event management system 110 can be implemented to manage relationships between clinical enterprise (e.g., a dental product supplier) and its partners (e.g., speakers, key opinion leaders, contracted doctors, other stakeholders) and further facilitate and coordinate the participation of the partners in the clinical enterprise-related events to present the information related to products and services of the clinical enterprise. Additionally, a peer-to-peer platform, which may be a part of or separate from event management system 110, may be implemented to manage relationships and communications between an enterprises partners.

The example event management system 110 in environment 200 shown in FIG. 2 includes an event coordinator 202, a partner information manager 204, a partner management database 206, and a controller 208.

According to some examples, event coordinator 202 functions to access partner information associated with the enterprise (e.g., enterprise 102 as illustrated in FIG. 1). Such partner information may be stored in partner management database 206, which may be managed and/or controlled by partner information manager 204. For example, partner information manager 204 can store any information related to partners in association with the enterprise.

In some examples, partner information manager 204 can be integrated as part of, or otherwise have access to, a customer relationship management (herein “CRM”) system of the enterprise. For example, partner information manager 204 can gather partners’ information through a CRM system used by the enterprise in managing partners relationships.

According to some examples, partner management database 206 functions to store partners’ information related to the partners (e.g., partners 140 as illustrated in FIG. 1) in association with the enterprise (e.g., enterprise 102 as illustrated in FIG. 1). In some examples, partner management database 206 is a cloud database, which can be accessed through a cloud environment, for example, across various devices.

In some instances, the partners’ information stored in partner management database 206 can include qualifications, education, credentials, industry affiliations, languages, geographic information (e.g., locations), types of services or practice, statuses, and/or any other applicable attributes of partners 140. Further, the partners’ information can include characteristics of the partners such as a subject matter of which partners have presented at a similar event in the past, a subject matter of which partners are specialized in, a subject matter of which partners can present at enterprise-related events, etc. In some examples, the partners’ information stored in partner management database 206, can include historical data relating to partner’s involvements in enterprise-related events (e.g., past presentation materials, recordings, transcripts, etc.) or interactions with the enterprise.

In some instances, the partners’ information can include a temporal availability (e.g., no availability on weekends, blackout dates, etc.), geographical availability, dietary restrictions (e.g., allergies, religious food restrictions, etc.), special accommodations such as disabilities, medical conditions, or other partners’ preferences (e.g., types of lodging, modes of transportations, duration of travel, etc.).

Furthermore, partner management database 206 can store information relating to enterprise-related events (e.g., event details) during which the partners of the enterprise can participate and present information relating to the products and/or services of the enterprise. For example, partner management database 206 can store event details such as topics, locations, dates, sponsors, programs, activities, rates, attire requirements, or any applicable information relating to the events.

According to some examples, based on the partners’ information such as an experience level or a role of the partners in relation to enterprise-related events, partner information manager 204 can determine a tier for each partner whose information is stored in partner management database 206. As follows, the tier can be used as one of the filters for filtering a candidate partner to participate in one of the enterprise-related events. Also, in some instances, the tier can be used to determine appropriate fees (e.g., fair market values) for respective partner. According to some examples, the tier can be determined based on evaluating a number of values relating to experiences, practice, education, other qualifications such as academic areas, publications of each partner.

According to some examples, event coordinator 202 functions to identify an enterprise-related event during which partners of the enterprise can present information related to the enterprise (e.g., products or services provided by the enterprise). As follows, event coordinator 202 functions to manage the participation of one or more partners associated with the enterprise in the event, which can include identifying a candidate partner who is suitable to present the enterprise-related information at the identified event based on the partners’ information and event details.

Further, event coordinator 202 can contact the candidate partner to facilitate the participation of the partner in the enterprise-related event based on the partners’ information stored in partner management database 206 such as the partners’ contact information or the partners’ preferences.

According to some examples, event coordinator 202 can arrange and coordinate the participation of the partner in the enterprise-related event including a registration, scheduling of travels, budgeting, and/or any logistics related to the enterprise-related event.

According to some examples, controller 208 functions to control the degree of access by the partners to the event-related data and the partners’ information based on a relation between the enterprise and the partners. In some examples, depending on an experience level, the length of the contract between the partners and the enterprise, or any applicable credentials or attributes of the partners, the degree of access to the data and/or information stored in partner management database 206 can be determined.

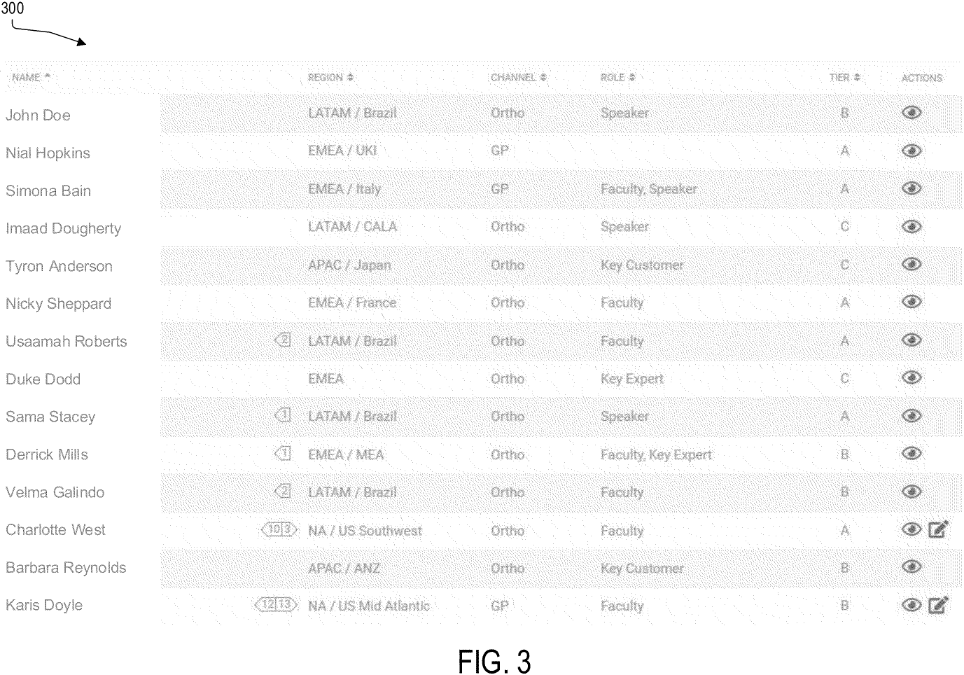

FIG. 3 is a screenshot 300 of an example interface for coordinating events and facilitating the participation of partners at the enterprise-related events based on enterprise-partner relationship management. In some examples, the interface can be presented to contact representatives or event coordinators of an enterprise. In turn, the contact representatives or event coordinators can find and contact different partners displayed through the interface based on the availability, eligibility, or suitability of the partners to participate in enterprise-related events.

Specifically and as shown in screenshot 300 of FIG. 3, the interface can display a list of available partners based on the partner management database described herein (e.g., partner management database 206 as illustrated in FIG. 2). Further, the interface can include names of the partners, regions of the partners, channels (i.e., types of practice or services of the partners such as general practice, orthodontics, or lab), roles of the partners (e.g., faculty, key expert, speaker, lab, regional ad board, global ad board, or key customer), and/or tiers of the partners.

In some examples, the interface can include various filters where the list of partners can be filtered based on specified criteria. As previously described, examples of the filters (i.e., criteria) can include but are not limited to, a temporal availability of the partners in relation to scheduled dates and time of the event, a geographical availability filter based on a geographic availability of the partners in relation to a venue of the event, an experience level filter or a specialty filter based on an experience level, a specialty, affiliation, or credentials of the partners in relation to a subject matter of the event, a role filter based on a role of the partners in relation to the event (e.g., speaker, key opinion leader, commentator, etc.), a faculty tier filter based on a faculty tier of the partners, a priority filter based on a priority of the partners in relation to the clinical enterprise, or a combination thereof.

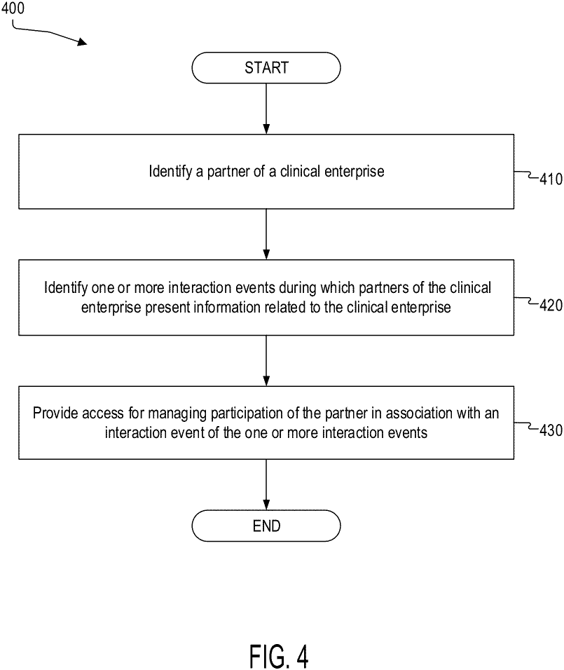

FIG. 4 illustrates a flowchart for an example method 400 of providing access for managing events based on partner relationship management. The method shown in FIG. 4 is provided by way of example, as there are a variety of ways to carry out the method. Additionally, while the example method is illustrated with a particular order of steps, those of ordinary skill in the art will appreciate that FIG. 4 and the modules shown therein can be executed in any order and can include fewer or more modules than illustrated. Each module shown in FIG. 4 represents one or more steps, processes, methods or routines in the method.

At step 410, method 400 includes identifying a partner of a clinical enterprise. For example, as illustrated in FIGS. 1 and 2, partner information manager 204 of event management system 110 can identify a partner (e.g., partner 140-1) of a clinical enterprise (e.g., enterprise 102) based on partner management database 206.

In some examples, the clinical enterprise (e.g., enterprise 102 as illustrated in FIG. 1) is a clinical product supplier that distributes clinical products through a provider network. For example, the clinical product supplier can be a manufacturer of dental appliances, the clinical products are dental appliances, and the provider network is a network of dentists that facilitate provisioning of the dental appliances to patients.

In some examples, the partner (e.g., partners 140 as illustrated in FIG. 1) can be a contracted speaker of the clinical enterprise, a faculty member of the clinical enterprise, an expert in a field associated with the clinical enterprise, or a customer of the clinical enterprise.

At step 420, method 400 includes identifying one or more interaction events during which partners of the clinical enterprise present information related to the clinical enterprise. For example, as illustrated in FIGS. 1 and 2, partner information manager 204 of event management system 110 can identify one or more enterprise-related events during which partners 140 of enterprise 102 present information related to enterprise 102. For example, event management system 110 can identify a global dental conference during which a contracted dentist associated with a dental product supplier can present information relating to dental appliances manufactured by the dental product supplier.

At step 430, access for managing participation of the partner in association with an interaction event of the one or more interaction events is provided. For example, event management system 110 can provide access for managing participation of partner 140-1 in association with the clinical enterprise-related event of the one or more interaction events. In some examples, the access can be provided by the clinical enterprise (e.g., enterprise 102 as illustrated in FIG. 1). In other examples, the access can be provided by an entity that is distinct from the clinical enterprise.

According to some examples, method 400 includes providing access to scheduling tools for scheduling the partner to participate in the interaction event as part of providing the access for managing participation of the partner in association with the interaction event. For example, as illustrated in FIGS. 1 and 2, event coordinator 202 of event management system 110 can provide access to scheduling tools for scheduling partner 140-1 to participate in the enterprise-related event.

In some instances, the scheduling tools include one or more filters for filtering the partner (e.g., partner 140-1 in FIG. 1) from a plurality of partners (e.g., partners 140 in FIG. 1) based on partner characteristics. Examples of the filters include, but are not limited to, a temporal availability filter for filtering the plurality of partners based on a temporal availability of the partners in relation to a temporal schedule of the interaction event, a geographical availability filter for filtering the plurality of partners based on a geographic availability of the partners in relation to a geographic schedule of the interaction event, an experience level filter for filtering the plurality of partners based on an experience level of the partners in relation to a subject matter of the interaction event, a role filter for filtering the plurality of partners based on a role of the partners in relation to the interaction event, a faculty tier filter for filtering the plurality of partners based on a faculty tier of the partners, a priority filter for filtering the plurality of partners based on a priority of the partners in relation to the clinical enterprise, or a combination thereof.

In some examples, method 400 includes receiving input that is generated by the clinical enterprise through the scheduling tools regarding scheduling of one or more partners including the partner to participate in the interaction event. For example, as illustrated in FIGS. 1 and 2, event coordinator 202 of event management system 110 can receive input that is generated by enterprise 102 through the scheduling tools regarding scheduling of one or more partners 140 including the partner 140-1 to participate in the enterprise-related event. Such input can be used to determine conditions or criteria for identifying a candidate partner to participate in the enterprise-related event.

As follows, method 400 includes scheduling the partner to participate in the interaction event based on the input. For example, as illustrated in FIGS. 1 and 2, event coordinator 202 of event management system 110 can schedule partner 140-1 to participate in the enterprise-related event based on the input that is generated by enterprise 102. More specifically, event coordinator 202 can select partner 140-1 based on the input that is generated by enterprise 102. As follows, event coordinator 202 can contact partner 140-1 or instruct representatives of enterprise 102 to contact partner 140-1 to facilitate the participation of partner 140-1 in the enterprise-related event during which partner 140-1 present information related to enterprise 102.

According to some examples, method 400 includes identifying one or more actions for the partner to take in participating in the interaction event. For example, as illustrated in FIGS. 1 and 2, event coordinator 202 of event management system 110 can identify one or more actions for partner 140-1 to take in participating in the enterprise-related event (e.g., acceptance of an invitation for the enterprise-related event). Further, method 400 includes facilitating performance of the one or more actions by the partner. For example, as illustrated in FIGS. 1 and 2, event coordinator 202 of event management system 110 can facilitate performance of the one or more actions by partner 140-1.

According to some examples, method 400 includes managing transfer of consideration to the partner based on the participation of the partner in the interaction event. For example, as illustrated in FIGS. 1 and 2, event coordinator 202 of event management system 110 can manage transfer of consideration to partner 140-1 (i.e., make payments) based on the participation in the enterprise-related event.

Further, method 400 includes maintaining a datastore of characteristics of the partners including the partner in relation to the clinical enterprise. For example, as illustrated in FIGS. 1 and 2, event management system 110 can maintain partner management database 206 to store characteristics of partners 140 including partner 140-1 in relation to enterprise 102.

As follows, method 400 includes selecting the partner as a candidate partner for participating in the interaction event based on the characteristics of the partners in relation to the clinical enterprise. For example, as illustrated in FIGS. 1 and 2, event coordinator 202 of event management system 110 can select partner 140-1 as a candidate partner for participating in the enterprise-related event based on the characteristics of partners 140 in relation to enterprise 102.

According to some examples, method 400 includes controlling access by the partner to data associated with the interaction event based on a relation between the partner and the clinical enterprise. For example, as illustrated in FIGS. 1 and 2, controller 208 of event management system 110 can control access by partner 140-1 to data associated with the enterprise-related event based on a relation between partner 140-1 and enterprise 102. More specifically, a dentist on a short-term contractual basis can have a limited access to data associated with the enterprise-related event.

In some examples, method 400 includes identifying needs of the partner in participating in the interaction event. For example, as illustrated in FIGS. 1 and 2, event coordinator 202 of event management system 110 can identify needs of partner 140-1 in participating in the enterprise-related event. Further, method 400 includes coordinating performing of the needs for the partner. For example, as illustrated in FIGS. 1 and 2, event coordinator 202 of event management system 110 can coordinate performing of the needs for partner 140-1. More specifically, the needs of the partner in participating in the interaction event can include dietary restrictions (e.g., allergies, religious food restrictions, etc.), special accommodations such as disabilities, medical conditions, or other partners’ preferences (e.g., types of lodging, modes of transportations, duration of travel, etc.).

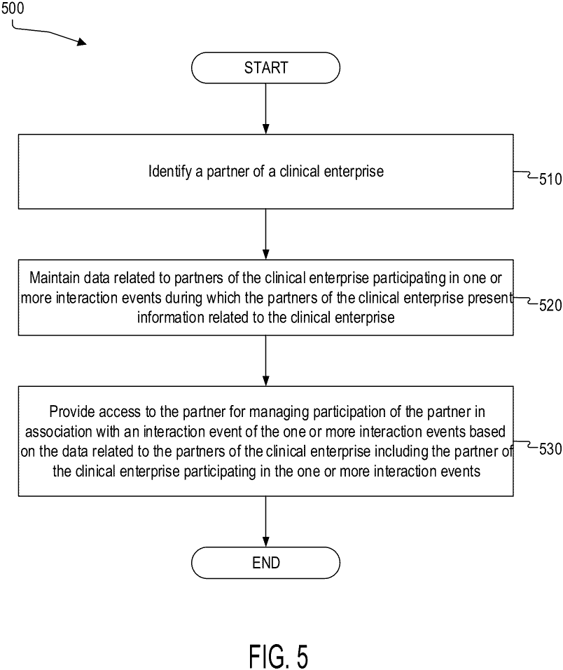

FIG. 5 illustrates a flowchart for an example method 500 of providing access to a partner for managing events based on partner relationship management. The method shown in FIG. 5 is provided by way of example, as there are a variety of ways to carry out the method. Additionally, while the example method is illustrated with a particular order of steps, those of ordinary skill in the art will appreciate that FIG. 5 and the modules shown therein can be executed in any order and can include fewer or more modules than illustrated. Each module shown in FIG. 5 represents one or more steps, processes, methods or routines in the method.

At step 510, method 500 includes identifying a partner of a clinical enterprise. As previously described, the clinical enterprise (e.g., enterprise 102 as illustrated in FIG. 1) is a clinical product supplier that distributes clinical products through a provider network. For example, the clinical product supplier is a manufacturer of dental appliances, the clinical products are dental appliances, and the provider network is a network of dentists that facilitate provisioning of the dental appliances to patients. In some instance, the partner (e.g., partner 140-1 as illustrated in FIG. 1) can be a contracted speaker of the clinical enterprise, a faculty member of the clinical enterprise, an expert in a field associated with the clinical enterprise, or a customer of the clinical enterprise.

At step 520, method 500 includes maintaining data related to partners of the clinical enterprise participating in one or more interaction events during which the partners of the clinical enterprise present information related to the clinical enterprise. For example, as illustrated in FIGS. 1 and 2, event management system 110 can maintain data related to partners 140 of enterprise 102 participating in one or more enterprise-related events during which partners 140 of enterprise 102 present information related to enterprise 102 in partner management database 206.

At step 530, access to the partner for managing participation of the partner in association with an interaction event of the one or more interaction events is provided based on the data related to the partners of the clinical enterprise including the partner of the clinical enterprise participating in the one or more interaction events. For example, as illustrated in FIGS. 1 and 2, event management system 110 can provide access to partner 140-1 for managing the participation of partner 140-1 in association with an enterprise-related event of the one or more enterprise-related events based on the data related to partners 140 of enterprise 102 including partner 140-1 participating in the enterprise-related event.

According to some examples, method 500 includes identifying that the partner is engaged to participate in the interaction event of the clinical enterprise. For example, event management system 110 can determine that partner 140-1 is engaged to participate in the enterprise-related event.

Further, method 500 includes providing the partner access to participation information related to the partner participating in the interaction event based on identifying that the partner is engaged to participate in the interaction event. For example, as illustrated in FIGS. 1 and 2, event coordinator 202 of event management system 110 can provide partner 140-1 with access to participation information related to partner 140-1 participating in the enterprise-related event. In some examples, the participation information can include event details (e.g., dates, locations, topics, programs, rates, etc.), itineraries including bookings (e.g., flights, lodging, etc.), and/or presentation materials for partner 140-1.

According to some examples, method 500 includes receiving, from the partner, characteristics of the partner in relation to the clinical enterprise. For example, as illustrated in FIGS. 1 and 2, partner information manager 204 can receive, from partner 140-1, characteristics of partner 140-1 in relation to enterprise 102. Examples of the characteristics provided by the partner include, but are not limited to, temporal characteristics of an availability of the partner, geographical characteristics of the availability of the partner, experience characteristics of the partner in relation to the clinical enterprise, role characteristics of the partner in relation to the clinical enterprise, faculty tier characteristics of the partner in relation to the clinical enterprise, priority characteristics of the partner in relation to the clinical enterprise, or a combination thereof. In some examples, partner information manager 204 can further store the characteristics of partner 140-1 in relation to enterprise 102 in partner management database 206 as illustrated in FIG. 2.

As follows, method 500 includes controlling selective scheduling of the partner to participate in the interaction event associated with the clinical enterprise based on the characteristics provided by the partner. For example, as illustrated in FIGS. 1 and 2, event coordinator 202 of event management system 110 can control selective scheduling of partner 140-1 to participate in the enterprise-related event associated with enterprise 102 based on the characteristics provided by partner 140-1. More specifically, the partner (e.g., partner 140-1) to participate in the interaction event can be selected by filtering the partners (e.g., partners 140) based on the characteristics of partners.

According to some examples, method 500 includes receiving, from the partner, payment information related to payment associated with the partner participating in the interaction event. For example, as illustrated in FIGS. 1 and 2, event coordinator 202 of event management system 110 can receive, from partner 140-1, payment information related to payment associated with partner 140-1 participating in the enterprise-related event. For example, partner 140-1 can submit a request for reimbursement, invoices, and/or receipts associated with participating in the enterprise-related event. In addition to the payment information received from the partner, in determining the payment associated with the partner participating in the interaction event, event management system 100 can take account for one or more relevant factors such as a location, a type of the event, a type of the partner, and a tier, more specifically, in order to determine an appropriate fair market value (FMV) based on the partner.

Further, method 500 includes managing transfer of consideration to the partner based on the participation of the partner in the interaction event and the payment information. For example, as illustrated in FIGS. 1 and 2, event coordinator 202 of event management system 110 can manage transfer of consideration (i.e., make the payments) to partner 140-1 based on the participation of partner 140-1 in the enterprise-related event and the payment information received from partner 140-1.

According to some examples, method 500 includes identifying the status of the partner in relation to the clinical enterprise. For example, partner information manager 204 can identify a status of partner 140-1 in relation to enterprise 102, for example, based on experience level, the length of the contract between enterprise 102 and partner 140-1, or any applicable credentials or attributes of partner 140-1.

As follows, method 500 includes controlling accessing of the partner to information of the clinical enterprise in association with the interaction event based on the status of the partner in relation to the clinical enterprise. For example, partner information manager 204 as illustrated in FIG. 2 can control accessing of partner 140-1 to information of enterprise 102 in association with the enterprise-related event based on the status of partner 140-1 in relation to enterprise 102.

According to some examples, method 500 includes gathering feedback from participants in the interaction event. For example, as illustrated in FIGS. 1 and 2, event coordinator 202 of event management system 110 can gather feedback from participants in the enterprise-related event. Further, method 500 includes providing the partner with access to the feedback. For example, as illustrated in FIGS. 1 and 2, event coordinator 202 of event management system 110 can provide partner 140-1 with access to the feedback.

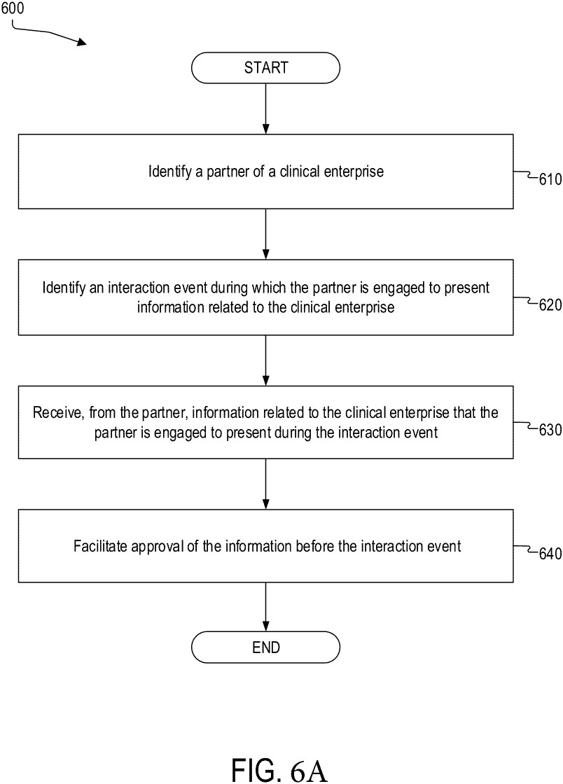

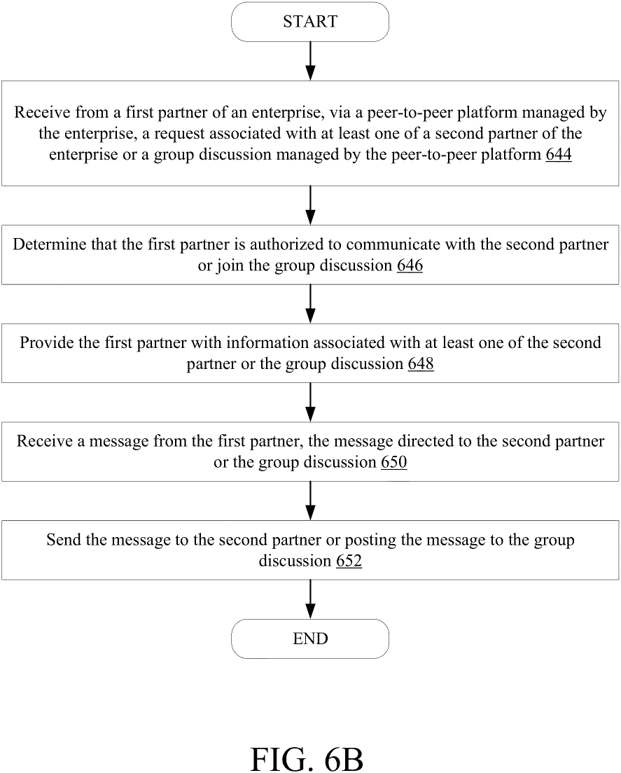

FIG. 6A illustrates a flowchart for an example method 600 of coordinating and facilitating the participation of a partner at an event. The method shown in FIG. 6A is provided by way of example, as there are a variety of ways to carry out the method. Additionally, while the example method is illustrated with a particular order of steps, those of ordinary skill in the art will appreciate that FIG. 6A and the modules shown therein can be executed in any order and can include fewer or more modules than illustrated. Each module shown in FIG. 6A represents one or more steps, processes, methods or routines in the method.

At step 610, method 600 includes identifying a partner of a clinical enterprise. As previously described, the clinical enterprise (e.g., enterprise 102 as illustrated in FIG. 1) is a clinical product supplier that distributes clinical products through a provider network. For example, the clinical product supplier is a manufacturer of dental appliances, the clinical products are dental appliances, and the provider network is a network of dentists that facilitate the provisioning of the dental appliances to patients. In some instances, the partner (e.g., partner 140-1 as illustrated in FIG. 1) can be a contracted speaker of the clinical enterprise, a faculty member of the clinical enterprise, an expert in a field associated with the clinical enterprise, or a customer of the clinical enterprise.

At step 620, method 600 includes identifying an interaction event during which the partner is engaged to present information related to the clinical enterprise. For example, as illustrated in FIGS. 1 and 2, partner information manager 204 of event management system 110 can identify an enterprise-related event during which partner 140-1 of enterprise 102 present information related to enterprise 102. For example, event management system 110 can identify a global dental conference during which a contracted dentist associated with a dental product supplier can present information relating to dental appliances manufactured by the dental product supplier.

At step 630, information related to the clinical enterprise that the partner is engaged to present during the interaction event can be received from the partner. For example, as illustrated in FIGS. 1 and 2, event coordinator 202 of event management system 110 can receive, from partner 140-1, information related to enterprise 102 that partner 140-1 is engaged to present during the enterprise-related event. Examples of the information can include but are not limited to presentation materials, transcripts, samples, slides deck, videos, or any other applicable information that can be used during the presentation at the enterprise-related events.

At step 640, approval of the information before the interaction event can be facilitated. For example, as illustrated in FIGS. 1 and 2, event coordinator 202 of event management system 110 can facilitate approval of the information before the enterprise-related event, for example, from various departments of enterprise 102.

According to some examples, method 600 includes sending the information to various departments or groups associated with the clinical enterprise such as a clinical department, a legal department, a regulatory department, and/or a panel a panel consisting of peer partners or a few selected partners of the clinical enterprise. As follows, method 600 includes gaining, at least in part, clinical approval of the information from the respective department or group as part of facilitating the approval of the information before the interaction event. For example, various departments or groups associated with enterprise 102 can review the information that partner 140-1 is engaged to present during the enterprise-related event to determine the sufficiency of the information or confirm if the information is in compliance with rules, laws, or regulations.

According to some examples, method 600 includes facilitating the collaborative transfer of the information between a plurality of departments (e.g., a clinical department, a legal department, a regulatory department, and/or a panel) for approving the information, and the collaborative transfer includes transferring department-specific data related to the approval of the information between the plurality of departments.

In some examples, method 600 includes receiving feedback relating to the information from the plurality of departments (e.g., a clinical department, a legal department, a regulatory department, and/or a panel). For example, as illustrated in FIGS. 1 and 2, event coordinator 202 of event management system 110 can gather feedback relating to the information from the plurality of departments.

According to some examples, method 600 includes informing the partner whether the information is approved before the interaction event based on the approval of the information before the interaction event. For example, as illustrated in FIGS. 1 and 2, event coordinator 202 of event management system 110 can forward the feedback relating to the information from the plurality of departments, whether the information is approved or rejected, before the enterprise-related event.

According to some examples, method 600 includes identifying one or more reasons why the information is rejected. As follows, method 600 includes informing the partner of the one or more reasons why the information is rejected. as illustrated in FIGS. 1 and 2, event coordinator 202 of event management system 110 can identify, if the information is rejected, one or more reasons of the rejection and inform partner 140-1 of the one or more reasons.

In some examples, communications between the clinical enterprise and the partner regarding the information that the partner is engaged to present during the interaction event can be exchanged efficiently before, during, and/or after the interaction event. Such communications and data shared during the communications can be stored in a database associated with the clinical enterprise (e.g., partner management database 206 as illustrated in FIG. 2) for a certain period of time so that the clinical enterprise and the partner can easily access the records of the communications. Also, the length of time external from participants that the records to be maintained in the database can be determined by the clinical enterprise based on a relationship between the clinical enterprise and the partner, a status of the partner, a tier of the partner, a priority of the partner, or any applicable information associated with the partner.

According to some examples, method 600 includes receiving modified information based on the informing of the partner of the one or more reasons why the information is rejected. as illustrated in FIGS. 1 and 2, event coordinator 202 of event management system 110 can receive modified information based on the informing of partner 140-1 of the one or more reasons why the information is rejected for review and approval from the plurality of departments.

FIG. 6B illustrates a flowchart for an example method of managing peer interaction on a peer-to-peer platform managed by an enterprise, in accordance with some examples. The method of FIG. 6B may be performed by a processing logic that may comprise hardware (e.g., circuitry, dedicated logic, programmable logic, microcode, etc.), software (e.g., instructions run on a processing device to perform hardware simulation), or a combination thereof. In one embodiment, at least some operations of the method are performed by a computing device executing a peer-to-peer platform.

For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

At block 644 processing logic receives, from a first partner of an enterprise and via a peer-to-peer platform managed by the enterprise, a request associated with at least one of a second partner of the enterprise or a group discussion managed by the peer-to-peer platform. The first partner may satisfy one or more confidentiality requirements. Additionally, or alternatively, the second partner and/or all partners participating in the group discussion may satisfy one or more confidentiality requirements. The one or more satisfied confidentiality requirements may cause the first partner, the second partner and/or all partners participating in the group discussion to maintain confidentiality of contents of any communications, data, messages, etc. communicated between the partners and/or to the discussion group. Accordingly, the peer-to-peer platform may provide a safe environment for doctors to exchange ideas and consult with one another about patient cases without violating Health Insurance Portability and Accountability Act (HIPAA) and/or other patient privacy rules. The request may be a search request comprising a search for at least one of a partner or a group discussion having at least one of a specified medical specialty, a specified geographic area, a specified work history, a specified name, a specified temporal availability, a specified role, a specified title, and so on.

At block 646, processing logic determines that the first partner is authorized to communicate with the second partner and/or join the group discussion. This may include determining that the first partner has at least one of a clearance level or a partner class that permits communication with the second partner. This may include determining that the first partner has signed and/or agreed to certain confidentiality requirements such as a non-disclosure agreement (NDA).

At block 648, processing logic provides the first partner with information associated with at least one of the second partner or the group discussion. At block 650, processing logic receives a message from the first partner, the message directed to the second partner or the group discussion. The message may include patient case details, medical images, and/or a treatment plan in some examples. The message may be or include an invitation for the second partner to join the group discussion in an example. At block 652, processing logic sends the message to the second partner or posts the message to the group discussion.

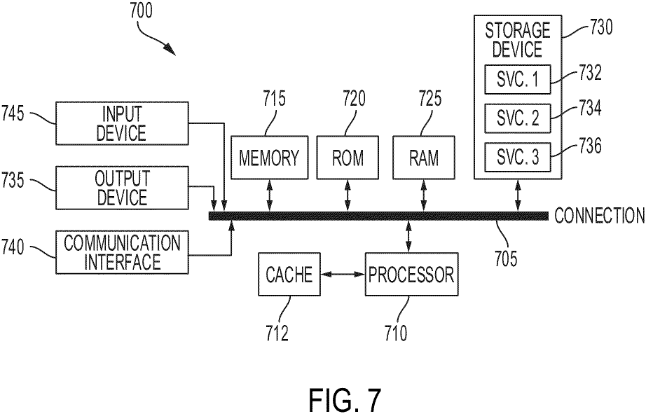

The disclosure now turns to FIG. 7 which illustrates an example of a bus computing system 700 wherein the components of the system are in electrical communication with each other using a bus 705. The computing system 700 can include a processing unit (CPU or processor) 710 and a system bus 705 that may couple various system components including the system memory 715, such as read only memory (ROM) 720 and random access memory (RAM) 725, to the processor 710. The computing system 700 can include a cache 712 of high-speed memory connected directly with, in close proximity to, or integrated as part of the processor 710. The computing system 700 can copy data from the memory 715, ROM 720, RAM 725, and/or storage device 730 to the cache 712 for quick access by the processor 710. In this way, the cache 712 can provide a performance boost that avoids processor delays while waiting for data. These and other modules can control the processor 710 to perform various actions. Other system memory 715 may be available for use as well. The memory 715 can include multiple different types of memory with different performance characteristics. The processor 710 can include any general purpose processor and a hardware module or software module, such as module 1 732, module 2 734, and module 3 736 stored in the storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing system 700, an input device 745 can represent any number of input mechanisms, such as a microphone for speech, a touch-protected screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing system 700. The communications interface 740 can govern and manage the user input and system output. There may be no restriction on operating on any particular hardware arrangement and therefore the basic features here may easily be substituted for improved hardware or firmware arrangements as they are developed.

The storage device 730 can be a non-volatile memory and can be a hard disk or other types of computer readable media which can store data that are accessible by a computer, such as magnetic cassettes, flash memory cards, solid state memory devices, digital versatile disks, cartridges, random access memory, read only memory, and hybrids thereof.

As discussed above, the storage device 730 can include the software modules 732, 734, 736 for controlling the processor 710. Other hardware or software modules are contemplated. The storage device 730 can be connected to the system bus 705. In some embodiments, a hardware module that performs a particular function can include a software component stored in a computer-readable medium in connection with the necessary hardware components, such as the processor 710, bus 705, output device 735, and so forth, to carry out the function. For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

What is claimed is:

1. A computer-implemented method comprising:
identifying a partner of a clinical enterprise;
identifying one or more interaction events during which partners of the clinical enterprise present information related to the clinical enterprise; and
providing access for managing participation of the partner in association with an interaction event of the one or more interaction events.

2. The computer-implemented method of claim 1, wherein the access for managing participation of the partner in association with the interaction event is provided by the clinical enterprise.

3. The computer-implemented method of claim 1, wherein the access for managing participation of the partner in association with the interaction event is provided by an entity that is distinct from the clinical enterprise.

4. The computer-implemented method of claim 1, wherein the partner is one of a contracted speaker of the clinical enterprise, a faculty member of the clinical enterprise, an expert in a field associated with the clinical enterprise, or a customer of the clinical enterprise.

5. The computer-implemented method of claim 1, wherein the clinical enterprise is a clinical product supplier that distributes clinical products through a provider network.

6. The computer-implemented method of claim 5, wherein the clinical product supplier is a manufacturer of dental appliances, the clinical products are dental appliances, and the provider network is a network of dentists that facilitate provisioning of the dental appliances to patients.

7. The computer-implemented method of claim 6, wherein the dental appliances comprise at least one of aligners with attachments, aligners without attachments, palatal expanders, dental braces, retainers, dental appliances to treat class I malocclusions, dental appliances to treat class II malocclusions, or dental appliances to treat class III malocclusions.

8. The computer-implemented method of claim 1, further comprising:
providing access to scheduling tools for scheduling the partner to participate in the interaction event as part of providing the access for managing participation of the partner in association with the interaction event;
receiving input that is generated by the clinical enterprise through the scheduling tools regarding scheduling of one or more partners including the partner to participate in the interaction event; and
scheduling the partner to participate in the interaction event based on the input.

9. The computer-implemented method of claim 8, wherein the scheduling tools include one or more filters for filtering the partner from a plurality of partners based on partner characteristics.

10. The computer-implemented method of claim 9, wherein the one or more filters include at least one of the following:
a temporal availability filter for filtering the plurality of partners based on a temporal availability of the partners in relation to a temporal schedule of the interaction event;
a geographical availability filter for filtering the plurality of partners based on a geographic availability of the partners in relation to a geographic schedule of the interaction event;
an experience level filter for filtering the plurality of partners based on an experience level of the partners in relation to a subject matter of the interaction event;
a role filter for filtering the plurality of partners based on a role of the partners in relation to the interaction event;
a faculty tier filter for filtering the plurality of partners based on a faculty tier of the partners; or
a priority filter for filtering the plurality of partners based on a priority of the partners in relation to the clinical enterprise.

11. The computer-implemented method of claim 1, further comprising:
identifying one or more actions for the partner to take in participating in the interaction event; and
facilitating performance of the one or more actions by the partner.

12. The computer-implemented method of claim 1, further comprising managing transfer of consideration to the partner based on the participation of the partner in the interaction event.

13. The computer-implemented method of claim 1, further comprising:
maintaining a datastore of characteristics of the partners including the partner in relation to the clinical enterprise; and
selecting the partner as a candidate partner for participating in the interaction event based on the characteristics of the partners in relation to the clinical enterprise.

14. The computer-implemented method of claim 1, further comprising controlling access by the partner to data associated with the interaction event based on a relation between the partner and the clinical enterprise.

15. The computer-implemented method of claim 1, further comprising:
identifying needs of the partner in participating in the interaction event; and
coordinating performing of the needs for the partner.

16. The computer-implemented method of claim 1, further comprising:
notifying the partner that one or more interaction events require one or more partner provided materials;
receiving the one or more partner provided materials;
determining one or more approvals required for the partner provided materials; and
notifying one or more entities to review the provided materials.

17. The computer-implemented method of claim 16, further comprising:
indicating in a notification to the one or more entities which other entities of the one or more entities have approved the partner provided materials and which other entities of the one or more entities have not approved the partner provided materials.

18. The computer-implemented method of claim 16, further comprising:
receiving a conditional approval of the partner provided materials by an entity of the one or more entities, wherein the conditional approval indicates that the partner provided materials will be approved responsive to one or more conditions being satisfied; and
notifying the partner of the one or more conditions of the conditional approval.

19. The computer-implemented method of claim 16, wherein the one or more partner provided materials comprises a presentation.

20. A system comprising:
one or more processors; and
at least one computer-readable storage medium having stored therein instructions which, when executed by the one or more processors, cause the one or more processors to:
identify a partner of a clinical enterprise;
identify one or more interaction events during which partners of the clinical enterprise present information related to the clinical enterprise; and
provide access for managing participation of the partner in association with an interaction event of the one or more interaction events.

21-96. (canceled)
